(19) United States
(12) Patent Application Publication
(10) Pub. No.: US 2026/0235990 A1
(43) Pub. Date: Aug. 13, 2026

(54) Stand-Alone Apparatus and Related Method for Determining an Interval of Time Elapsed From a Certain Instant of Time by a Person Who Carries Out an Activity

(71) Applicant: Patmos Unipessoal LDA, Funchal, Madeira (PT)

(72) Inventor: Robert James, Hatfield, Hertfordshire (GB)

(21) Appl. No.: 19/156,851

(22) PCT Filed: Feb. 17, 2023
(86) PCT No.: PCT/IB2023/051469

§ 371 Date: Aug. 14, 2025

(51) Int. Cl. G04G 13/00; G04G 21/06

(52) U.S. Cl. CPC G04G 13/00; G04G 21/06

(57) ABSTRACT

Stand-alone apparatus for determining an interval of time, when a watch is not directly accessible, including a reproduction component reproducing an audio content, an audio acquisition component picking up an audio signal as voice command, a processor communicating with the reproduction component, and an audio acquisition component, wherein the processor detects that the at least one audio content is being reproduced by the reproduction component, and generating a time datum representing a duration of at least one interval of time during which the at least one audio content has been reproduced, counting the duration of the at least one interval of time: either from the start of the reproduction of the at least one audio content or following the reception of a first voice command picked up by the audio acquisition component, and stopping the counting upon reception of a second voice command picked up by the audio acquisition component.

### BACKGROUND OF THE DISCLOSURE

### 1. The Field of the Disclosure

The present invention relates to a stand-alone apparatus and/or a method for determining an interval of time that has elapsed from a certain instant of time while a person is carrying out an activity under such conditions that a watch is not directly accessible, in particular, without being limited thereto, while the person is performing a physical activity. Furthermore, the present invention permits obtaining multiple determinations of intervals of time elapsed in succession.

### 2. The Relevant Technology

As is known, when performing certain activities, it is not advisable to wear a watch, in particular a wrist watch, because during such activities a watch may hinder a person's movements or be damaged by accidental shocks, e.g., when one is engaged in heavy manual work. In such cases, it is therefore virtually impossible for the person engaged in such activities to be aware of the time that has elapsed from a certain instant of time. There are also other types of physical activities, such as aerobic activities (e.g., aquacise, swimming, running, cycling, etc.), where it is difficult to automatically keep track of the time that has elapsed during the activity without having direct access to a watch or using dedicated sensors (e.g., a smartwatch comprising a heart rate monitor and/or a gyroscope) applied to the body of the person who is performing said activity.

Moreover, when the activity is carried out indoors, it is not even possible to use a device (e.g., a smartphone) equipped with a GNSS receiver, because global positioning capabilities are not useful for keeping track of the duration of an indoor activity such as, for example, bicycle ergometer, treadmill, or the like.

As a matter of fact, it is very often the case that a person would like to know how much time has passed from the moment when a physical activity was started, while however not having a watch readily available because wearing and/or looking at a watch would be uncomfortable and/or dangerous, e.g., when carrying out heavy manual work, or while swimming, skiing, running, cycling or lifting weights, or when performing other similar activities.

### SUMMARY OF THE DISCLOSURE

The present invention aims at solving these and other problems by providing a stand-alone apparatus (e.g., audio reproduction means equipped with a microphone) and a related method for determining an interval of time that has elapsed from a certain instant of time while a person is carrying out an activity under such conditions that a watch is not directly accessible.

Furthermore, the present invention also provides a computer program product which can be loaded into the memory of a stand-alone apparatus comprising reproduction means adapted to reproduce at least one audio content and audio acquisition means adapted to pick up an audio signal containing a voice command, said computer program product comprising portions of software code for executing the phases of the method according to the invention.

“Stand-alone apparatus” refers herein to an apparatus that can operate alone or anyway independently of any other external device or software, e.g., a smartphone app.

More particularly, the stand-alone apparatus according to the present invention does not require, in order to operate correctly, either an Internet connection or a cloud connection.

The basic idea of the present invention is to associate with an activity, during which a watch is not directly accessible, the use of a stand-alone apparatus equipped with a microphone and with an internal clock, which starts counting the time that has elapsed since the start of the reproduction of an audio content, and which is stopped upon receiving a voice command ending the elapsed time count. Any subsequent elapsed time counts will be activated upon receiving subsequent voice commands for ending the elapsed time count.

Furthermore, still using the microphone and the internal clock of the stand-alone apparatus, the idea of the present invention consists of using the duration of an audio content reproduced by audio reproduction means, said audio content being selected by means of commands issued by the user, as a basis for counting a time datum representing a duration of at least one interval of time during which said audio content has been reproduced, and determining at least one activity datum concerning heavy manual activities or physical activities on the basis of at least said time datum.

In particular, this makes it possible to determine the duration of a physical activity without having to use any dedicated sensors. It is thus possible to reduce the risk of muscular overload for people carrying out physical activities without using dedicated devices.

Furthermore, when the user wants to know how much time has passed since the start of the activity (when the reproduction of the audio content was started in the form of a continuous sequence of music and/or voice tracks), upon reception of a time determination keyword, e.g., “time”, picked up by a microphone within the stand-alone apparatus, the latter will read the clock of the apparatus and will communicate, through an associated loudspeaker how much time has elapsed since the reproduction of the series of music and/or voice tracks was started or, afterwards, further determinations of the interval of time that has elapsed since the keyword “time” was last received.

Other keywords may be used as well, such as “start”, for starting the counting, and “stop”, to stop the counting.

The reception of the keyword “time” does not, however, stop the time base count at a certain instant of time, and the user may ask how much time has elapsed from a certain instant of time several times in succession. The time count will only be stopped if the reproduction of said series of music and/or voice tracks is stopped and/or if, preferably, the keyword “stop” is uttered.

It is clear that said voice commands are especially useful when the user is at some distance from the microphone-equipped apparatus, which may be, for example, a smartphone, and is listening to music by means of wireless earbuds or loudspeakers.

It is also clear that the keywords “start”, “time” and “stop” may be replaced with equivalent or similar words without however affecting the protection scope of the present invention.

In addition, and in combination with one or more of the here described embodiments in accordance with the present invention, it is envisaged, that the stand-alone apparatus is adapted to output acoustically the counted duration of at least one interval of time through the reproduction means. The outputting of the at least one interval of time can be advantageously be performed after receiving a voice command such as “time”, “stop” or after a predetermined duration of time.

Further, according to an advantageous aspect of the present invention, the stand-alone apparatus is adapted to switch to a listening mode either from the start of the reproduction of the at least one audio content or following the reception of a first voice command picked up by the audio acquisition means. The aforementioned listening mode is preferably configured to detect predetermined voice commands. Thus, the stand-alone apparatus is enabled to react and detect voice commands without any direct and approximate physical interaction with the user while being in the listening mode. The listening mode starts preferably after starting the reproduction of at least one audio content and/or after receiving an initial voice command.

According to a further advantageous aspect of the present invention, the stand-alone apparatus is adapted to receive and detect an activity type voice command and to assign the at least one interval of time to the activity type and to store the assignment in a memory of the stand-alone apparatus. In this way it is possible to create different assignments between time durations and certain activities.

With regard to a further advantageous aspect the stand-alone apparatus is adapted to output an acoustic warn signal through the reproduction means depending on the activity type and the at least one-time interval. In this way the apparatus provides safety and health securing measures to warn the user based on the performed type of activity and the corresponding counted activity duration in order to avoid physical health risks, by warning the user if certain maximum activity durations or predetermined activity durations are reached.

Further advantageous features of the present invention are set out in the appended claims, which are an integral part of the present description.

### BRIEF DESCRIPTION OF THE DRAWINGS

These features as well as further advantages of the present invention will become more apparent in the light of the following description of a preferred embodiment thereof as shown in the annexed drawings, which are provided herein merely by way of non-limiting example, wherein:

FIG. 1 is a block diagram showing the main elements of a stand-alone apparatus according to an embodiment of the present invention;

FIG. 2 is a flow chart showing an example of the flow of operations that are performed during the execution of a method according to the invention.

### DETAILED DESCRIPTION OF THE PREFERRED EMBODIMENTS

In this description, any reference to “an embodiment” will indicate that a particular configuration, structure or feature is comprised in at least one embodiment of the invention. Therefore, expressions such as “in an embodiment” and the like, which may be found in different parts of this description, will not necessarily refer to the same embodiment. Moreover, any particular configuration, structure or feature may be combined as deemed appropriate in one or more embodiments. The references below are therefore used only for simplicity's sake, and shall not limit the protection scope or extension of the various embodiments.

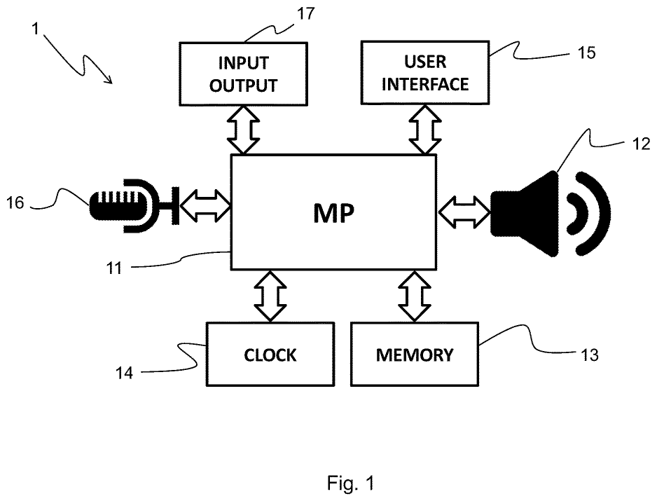

With reference to FIG. 1, the following will describe a stand-alone apparatus 1 according to the invention (which may be, as far as the essential parts required for its implementation are concerned, a microphone-equipped audio player) for determining an interval of time that has elapsed from a certain instant of time while a person is carrying out an activity under such conditions that a watch is not directly accessible.

Said stand-alone apparatus 1 preferably comprises the following parts:
processing means 11, e.g., a CPU, a microcontroller or the like, configured to execute a set of instructions implementing a method according to the invention;
reproduction means 12, e.g., either a conventional loudspeaker (if the processing means 11 can output a suitably amplified analogue signal) or an integrated circuit implementing audio decoding functions and converting a digital signal into an analogue signal and amplifying it so that it can be reproduced by the loudspeaker, said reproduction means 12 being adapted to diffuse at least one audio content in an environment where one or more persons are present;
memory means 13 (e.g., a RAM, ROM, SSD or Flash memory and/or another type of memory) adapted to store a set of instructions implementing a method for acquiring an interval of time that has elapsed from a certain instant of time while a person is carrying out an activity under such conditions that a watch is not directly accessible, and which can be read and executed by said processing means 11;
a clock 14 (which can be obtained in several ways, whether externally or internally to the processing means 11) configured to generate, for example, based on a signal having a known constant frequency, a timing signal that is inputted to said processing means 11;
interaction means 15 (e.g., a touchscreen) adapted to receive commands from said person, e.g., for reproducing a continuous series of music and/or voice tracks;
audio acquisition means 16, e.g., a microphone equipped with a chip configured to digitally encode a signal coming from said microphone and make it available to the processing means 11;
input/output (I/O) means 17, which can be used, for example, for connecting said apparatus 1 to a programming terminal configured for writing instructions (which the processing means 11 will have to execute) into the memory means 13; such input/output means 17 may comprise, for example, a USB, FireWire, RS232, RS485 or IEEE 1284 adapter, one or more general purpose input/output (GPIO) ports, or other ports for different purposes, e.g., for creating a wireless input/output system;
a communication bus allowing information to be exchanged among the processing means 11, the reproduction means 12, the memory means 13, the clock 14, the interaction means 15, the audio acquisition means 16 and the input/output (I/O) means 17.

As an alternative to the communication bus, it is possible to connect the processing means 11, the reproduction means 12, the memory means 13, the clock 14, the interaction means 15, the audio acquisition means 16 and the input/output (I/O) means 17 by means of a star architecture.

In order to prevent the reproduction means 12 from interfering with the picking up of the keywords, e.g. “start”, “time” and “stop”, by the audio acquisition means 16, the processing means 11 provide for, based on the recognition of an specific voice command (start-time-stop), obtained also by subjecting the audio content picked up by the acquisition means 16 to a spectral analysis, isolating and considering only the voice command (start-time-stop) in order to execute commands issued by the user.

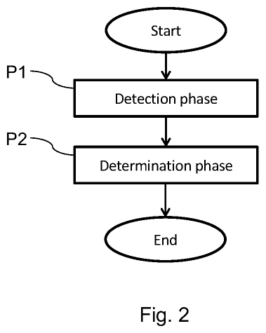

With reference to FIG. 2, when the apparatus 1 is in an operating condition, the processing means 11 execute a set of instructions implementing the method according to the invention; said method comprises the following phases:
an initialization phase (start), which can be activated when the reproduction means 12 are put in operation, starting the reproduction of a series of music and/or voice tracks of the apparatus 1, via the interaction means 15, e.g., by sending a “start” voice command to the apparatus 1 or by pressing a suitable icon on the screen of the apparatus 1, or upon reception, by the acquisition means 16, of the keyword “time” when the apparatus 1 is in an operating phase wherein the elapsed time count has already been communicated to the person following the reception, by the apparatus 1, of the keyword “time”. Therefore, on the one hand the keyword “time” causes the determination, and communication to the person, of the time that has elapsed from a certain reference time instant, while on the other hand it sets another reference time instant value from which the time count must restart;
a detection phase P1, wherein the processing means 11 detect that at least one audio content is being reproduced by the reproduction means 12, and generates a time datum representing a duration of at least one interval of time during which said at least one audio content has been reproduced;
a determination phase P2, wherein the processing means 11 determine at least one datum indicating the time elapsed during said activity on the basis of at least said time datum obtained by counting the time that has elapsed from a previously set time instant value;
a termination phase (end), which determines the end of the counting of the time elapsed from the first time instant value and of the communication to the person, via said reproduction means 12, of the elapsed interval of time. As aforementioned, the end of the counting of the elapsed interval of time also determines the start of the reference time point for the next determination of the time elapsed since the reception of the keyword “time”.

This makes it possible to detect the time that has elapsed while a person is carrying out an activity under such conditions that a watch is not directly accessible. In particular, if the person is carrying out a physical activity, this elapsed time can provide data about the person's workload without the necessity of using any dedicated sensors, and can quantify a parameter of said physical activity. This advantageously reduces the risk of muscular overload for a person performing said activity without using dedicated devices.

It must be pointed out that the apparatus 1 may be a smartphone, a loudspeaker connected via Bluetooth™ or another wireless system to another device, or another apparatus capable of reproducing a continuous series of music and/or voice tracks.

Phases P1 and P2 are cyclically repeated by the apparatus 1, so that an interruption of the reproduction of the audio content can be detected quickly and the physical activity can be tracked at best. In this regard, it must be pointed out that the reproduction of the audio content by the reproduction means 12 can be stopped by means of a further voice command (e.g., by uttering the keyword “stop”, which is acquired by the audio acquisition means 16 of the apparatus 1) or by means of a command for stopping the reproduction (e.g., one or more touches on the screen of the apparatus 1 via the interaction means 15).

In combination with the above, said at least one activity datum preferably comprises, when it concerns a physical activity, a duration datum representing a duration of said physical activity.

This makes it possible to quantify in a rather accurate manner the workload generated by a low-intensity aerobic physical activity (e.g., walking on flat ground, slow running, cycling on flat ground, or the like) during which the intensity of the physical load is low and constant over time. This advantageously reduces the risk of muscular overload for a person performing said physical activity without using dedicated devices.

Some of the possible variants of the invention have been described above, but it will be clear to those skilled in the art that other embodiments may also be implemented in practice, wherein several elements may be replaced with other technically equivalent elements. The present invention is not, therefore, limited to the above-described illustrative examples, but may be subject to various modifications, improvements, replacements of parts and equivalent elements without however departing from the basic inventive idea, as specified in the following claims.

For example, the input/output (I/O) means 17 may be employed, through the use of known wireless techniques (Bluetooth, Wi-Fi, etc.), for connecting and providing at least the audio content to external sound reproducing devices, such as headphones, earbuds or loudspeakers external to the apparatus 1. Of course, when sound sources external to the apparatus 1 are employed, the loudspeaker of the reproduction means 12 will not be used.

1. A stand-alone apparatus for determining an interval of time that has elapsed from a certain instant of time while a person is carrying out an activity under such conditions that a watch is not directly accessible, comprising:
reproduction means adapted to reproduce at least one audio content,
audio acquisition means adapted to pick up an audio signal containing a voice command,
processing means in communication with at least said reproduction means and said audio acquisition means,
wherein
said processing means are configured for
detecting that said at least one audio content is being reproduced by said reproduction means, and generating a time datum representing a duration of at least one interval of time during which said at least one audio content has been reproduced,
counting the duration of said at least one interval of time:
either from the start of the reproduction of said at least one audio content or following the reception of a first voice command picked up by said audio acquisition means,
and stopping said counting upon reception of a second voice command picked up by said audio acquisition means,
wherein said stand-alone apparatus is adapted to switch to a listening mode either from the start of the reproduction of said at least one audio content or following the reception of said first voice command picked up by said audio acquisition means, wherein said listening mode is in particular configured to detect predetermined voice commands.

2. The stand-alone apparatus according to claim 1, wherein said stand-alone apparatus is adapted to output acoustically said counted duration of said at least one interval of time through said reproduction means.

3. (canceled)

4. The stand-alone apparatus according claim 1, wherein said stand-alone apparatus is adapted to receive and detect an activity type voice command and to assign said at least one interval of time to said activity type and to store said assignment in a memory of said stand-alone apparatus.

5. The stand-alone apparatus according claim 1, wherein said stand-alone apparatus is adapted to output an acoustic warn signal through said reproduction means depending on said activity type and said at least one time interval.

6. The stand-alone apparatus according claim 1, wherein said first voice command picked up by said audio acquisition means and said second voice command picked up by said audio acquisition means comprise one same keyword.

7. The stand-alone apparatus according claim 1, wherein said audio acquisition means are adapted to receive said first and second voice commands multiple times as long as said audio content is reproduced by said audio reproduction means, resulting in the determination of multiple time data representing the respective durations of intervals of time elapsed since respective instants of time.

8. The stand-alone apparatus according claim 1, wherein said processing means are adapted to stop the counting of at least one interval of time only if the reproduction of said audio content is stopped or said acquisition means pick up a third voice command, said third voice command being different from said first and second voice commands.

9. The stand-alone apparatus according claim 1, wherein, in order to prevent the reproduction means from interfering with the picking up of said voice commands by said audio acquisition means, the processing means are configured for isolating and considering said voice commands apt to execute commands issued by the person by subjecting said voice commands picked up by said acquisition means to a spectral analysis.

10. The stand-alone apparatus according claim 1, wherein said at least one time datum comprises a duration datum representing a duration of a physical activity.

11. The stand-alone apparatus according claim 1, wherein said apparatus comprises a clock for counting said at least one interval of time that has elapsed.

12. The stand-alone apparatus according claim 1, comprising input/output means adapted to be used for connecting said apparatus to an external terminal or for creating a wireless communication input/output system with said reproduction means.

13. The stand-alone apparatus according claim 1, wherein said at least one audio content comprises a series of music and/or voice tracks.

14. A method for determining, by a stand-alone apparatus, an interval of time that has elapsed from a certain instant of time while a person is carrying out an activity under such conditions that a watch is not directly accessible, said stand-alone apparatus comprising:
reproduction means adapted to reproduce at least one audio content,
audio acquisition means adapted to pick up an audio signal containing a voice command,
processing means in communication with at least said reproduction means and said audio acquisition means,
the method comprising:
detecting, through said processing means, that said at least one audio content is being reproduced by said reproduction means, and generating a time datum representing a duration of at least one interval of time during which said at least one audio content has been reproduced,
counting, through said processing means, the duration of said at least one interval of time:
either from the start of the reproduction of said at least one audio content or following the reception of a first voice command picked up by said audio acquisition means,
and stopping said counting upon reception of a second voice command picked up by said audio acquisition means
wherein said stand-alone apparatus is adapted to switch to a listening mode either from the start of the reproduction of said at least one audio content or following the reception of said first voice command picked up by said audio acquisition means, wherein said listening mode is in particular configured to detect predetermined voice commands.

15. The method according to claim 14, wherein said stand-alone apparatus outputs acoustically said counted duration of said at least one interval of time through said reproduction means.

16. (canceled)

17. The method according to claim 14, wherein said stand-alone apparatus receives and detects an activity type voice command and assigns said at least one interval of time to said activity type and stores said assignment in a memory of said stand-alone apparatus.

18. The method according to claim 14, wherein said stand-alone apparatus outputs an acoustic warn signal through said reproduction means depending on said activity type and said at least one time interval.

19. The method according to claim 14, wherein said audio acquisition means receive said first and second voice commands multiple times as long as said audio content is reproduced by said audio reproduction means, resulting in the determination of multiple time data representing the respective durations of intervals of time elapsed since respective instants of time.

20. The method according to claim 14 wherein said processing means stop the counting of at least one interval of time only if the reproduction of said audio content is stopped or said acquisition means pick up a third voice command, said third voice command being different from said first and second voice commands.

21. The method according to claim 14, wherein, in order to prevent the reproduction means from interfering with the picking up of said voice command by said audio acquisition means, the processing means are configured for isolating and considering said voice commands apt to execute commands issued by the person by subjecting said voice commands picked up by said acquisition means to a spectral analysis.

22. A computer program product which can be loaded into the memory of a stand-alone apparatus comprising reproduction means adapted to reproduce at least one audio content and audio acquisition means adapted to pick up an audio signal containing a voice command, said computer program product comprising portions of software code for executing the phases of the method according to claim 14.
